(19) United States
(12) Patent Application Publication
(10) Pub. No.: US 2025/0131145 A1
(43) Pub. Date: Apr. 24, 2025

(54) BLADE DESIGN METHOD, BLADE DESIGN SYSTEM, BLADE, AND EFFICIENT EQUAL-THICKNESS IMPELLER

(71) Applicant: WOLONG ELECTRIC GROUP CO., LTD., Zheijang (CN)

(72) Inventors: WEI CAO, Zheijang (CN); MIAOSEN WANG, Zheijang (CN); JIONGLI NI, Zheijang (CN); WUJIE CAI, Zheijang (CN); ZEJUN ZHANG, Zheijang (CN)

(73) Assignee: WOLONG ELECTRIC GROUP CO., LTD., Zheijang (CN)

(21) Appl. No.: 18/695,899

(22) PCT Filed: Jan. 12, 2022
(86) PCT No.: PCT/CN2022/071531

§ 371 Date: Mar. 27, 2024

(30) Foreign Application Priority Data
Sep. 30, 2021 (CN) 202111161722.1

(51) Int. Cl. G06F 30/17; G06F 30/20

(52) U.S. Cl. CPC G06F 30/17; G06F 30/20

(57) ABSTRACT

Disclosed are a blade design method, a blade design system, a blade, and an efficient equal-thickness impeller. The blade design method comprises: obtaining target design parameters comprising a diameter of an impeller and the number of blades; determining a chord length of the blade according to the diameter of the impeller; according to the chord length of the blade, determining a camber of the blade corresponding to the chord length of the blade by means of a fitting optimization curve of the chord length and the camber; determining a height of the blade according to the diameter of the impeller and the number of blades; and obtaining an element of the blade according to the camber of the blade, and stretching a height of a corresponding position of the element of the blade to the height of the blade to obtain a target blade structure.

### CROSS-REFERENCE TO RELATED APPLICATION

This application is a U.S. National-Stage entry under 35 U.S.C. § 371 based on International Application No. PCT/CN2022/071531, filed Jan. 12, 2022, which was published under PCT Article 21(2) and which claims priority to Chinese Patent Application No. 202111161722.1, on Sep. 30, 2021 and entitled “Blade Design Method, Blade Design System, Blade, and Efficient Equal-Thickness Impeller”, the disclosure of which is hereby incorporated by reference in its entirety.

### TECHNICAL FIELD

The present disclosure relates to the technical field of fan design, and more particularly, to a blade design method. In addition, the present disclosure further relates to a blade design system, a blade, and an efficient equal-thickness impeller.

### BACKGROUND

A fan, as one of key devices of an energy device, has been continuously updated with advancing technology, and the pursuit of high efficiency has become an inevitable trend of the era for the fan, so that the design of a fan impeller has become the most critical step of fan design.

There are various design tools and design methods for the fan, but the design of an efficient fan not only needs strong theoretical support, but also needs a large number of verification of test data to finally obtain the design that meets the working condition points, and due to the complexity of the design process, the design efficiency is low.

In summary, how to solve the problem of low efficiency of fan design is an urgent problem to be solved by those skilled in the art.

### SUMMARY

In view of this, an objective of the present disclosure is to provide a blade design method, which can improve design efficiency.

Another objective of the present disclosure is to provide a blade design system, a blade, and an efficient equal-thickness impeller comprising the above blade design method.

In order to achieve the above objectives, the present disclosure provides the following technical solutions.

A blade design method comprises the following operations.

Target design parameters comprising a diameter of an impeller and the number of blades are obtained.

A chord length of the blade is determined according to the diameter of the impeller.

According to the chord length of the blade, a camber of the blade corresponding to the chord length of the blade is determined by means of a fitting optimization curve of the chord length and the camber.

A height of the blade is determined according to the diameter of the impeller and the number of blades.

An element of the blade is obtained according to the camber of the blade, and a height of a corresponding position of the element of the blade is stretched to the height of the blade to obtain a target blade structure.

Preferably, the operation that the chord length of the blade is determined according to the diameter of the impeller comprises the following operation.

The chord length of the blade is determined according to a formula L=(0.4−0.6)D.

Where L is the chord length of the blade and D is the diameter of the impeller.

Preferably, the operation that according to the chord length of the blade, the camber of the blade corresponding to the chord length of the blade is determined by means of the fitting optimization curve of the chord length and the camber comprises the following operation.

When the chord length of the blade is equally divided into n parts, and a reference position x is selected from 0, 1/n to n/n in sequence through a formula:

y=2.797x⁶−6.9249x⁵+5.8101x⁴−1.8368x³−0.4797x²+0.6343x;

h=Ly;

A camber h of n+1 reference positions x respectively corresponding to n+1 reference positions x is obtained.

Where y is a ratio of the camber of the reference position to the chord length of the blade, x is a ratio of the chord length of the reference position to the chord length of the blade, h is the camber of the reference position, and L is the chord length of the blade.

Preferably, n is greater than or equal to 4.

Preferably, the operation that the height of the blade is determined according to the diameter of the impeller and the number of blades comprises: determining the height of the blade through the following formula:

H=(0.5−2)D/z;
Where H is the height of the blade, D is the diameter of the impeller, and z is the number of blades.

Preferably, after the element of the blade is obtained according to the camber of the blade, and the height of the corresponding position of the element of the blade is stretched to the height of the blade to obtain the target blade structure, the method further comprises the following operations.

A wheel disc model and a wheel cover model are obtained.

A Boolean summation operation is performed on the target blade structure, the wheel disc model, and the wheel cover model to determine a final target impeller structure.

A blade design system comprises a data acquisition module, a design module, and a forming module.

The data acquisition module is configured to obtain target design parameters comprising a diameter of an impeller and the number of blades.

The design module is configured to determine a chord length of the blade according to the diameter of the impeller; determine, according to the chord length of the blade, a camber of the blade corresponding to the chord length of the blade by means of a fitting optimization curve of the chord length and the camber; and determine a height of the blade according to the diameter of the impeller and the number of blades.

The forming module is configured to obtain an element of the blade according to the camber of the blade, and stretch a height of a corresponding position of the element of the blade to the height of the blade to obtain a target blade structure.

The data acquisition module is connected to the design module, and the design module is connected to the forming module.

Optionally, the blade design system further comprises a model acquisition module and an operation module.

The model acquisition module is configured to obtain a wheel disc model and a wheel cover model.

The operation module is configured to perform a Boolean summation operation on the target blade structure, the wheel disc model, and the wheel cover model to determine the final target impeller structure. The operation module is connected to the model acquisition module and the forming module.

A blade is provided. The blade is obtained by the above blade design method.

An efficient equal-thickness impeller is provided, which comprises the above blade.

According to the blade design method provided by the present disclosure, the chord length of the blade, the camber of the blade, and the height of the blade are obtained by the obtained diameter of the impeller and the number of blades, where the camber of the blade is obtained by calculation through the existing fitting optimization curve. The selected fitting optimization curve may be a curve having the characteristics of high efficiency and small loss, so that the camber of the blade obtained by means of the current chord length of the blade and the fitting optimization curve also has the characteristics of the curve, that is, high efficiency and small loss. The element of the blade is obtained by the camber of the blade, and the element of the blade is stretched to obtain a blade profile, which has the characteristics of high efficiency and small loss. In this process, repeated checking and adjustment are not needed, and only the conditions of the fitting optimization curve need to be met, so that the design process is high in efficiency, the design mode is simple and convenient, and batch and rapid design can be realized.

The present disclosure further provides a blade design system, a blade, and an efficient equal-thickness impeller, all of which have the same use effect as the blade design method due to the use of the blade design method.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings described below are only embodiments of the present disclosure. Other drawings may further be obtained by those of ordinary skill in the art according to these drawings without creative efforts.

FIG. 1 is a flowchart of a blade design method provided by the present disclosure.

FIG. 2 is a schematic diagram of a target impeller structure provided by the present disclosure.

FIG. 3 is a schematic diagram of an element of a blade provided by the present disclosure.

FIG. 4 is a schematic diagram of a target blade structure provided by the present disclosure.

FIG. 5 is a schematic diagram of a fitting optimization curve provided by the present disclosure.

FIG. 6 is a relational graph between a flow rate and a pressure of a blade obtained by a method provided by the present disclosure when in use.

FIG. 7 is a relational graph between a flow rate and efficiency of a blade obtained by a method provided by the present disclosure when in use.

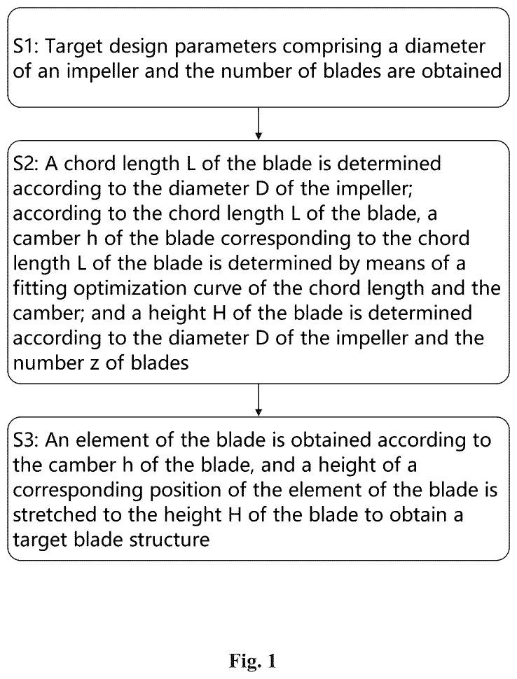

In FIG. 1 to FIG. 7:
1. Wheel cover model; 2. Wheel disc model; 3. Target blade structure; h. Camber of blade, L. Chord length of blade; H. Height of blade.

### DETAILED DESCRIPTION OF THE EMBODIMENTS

The technical solutions in the embodiments of the present disclosure will be clearly and completely described in conjunction with the drawings in the embodiments of the present disclosure. It is apparent that the described embodiments are only a part of the embodiments of the present disclosure, and not all of them. All other embodiments obtained by those of ordinary skill in the art based on the embodiments of the present disclosure without creative efforts are within the scope of protection of the present disclosure.

The core of the present disclosure is to provide a blade design method, which can improve design efficiency. Another core of the present disclosure is to provide a blade design system, a blade, and an efficient equal-thickness impeller comprising the above blade design method.

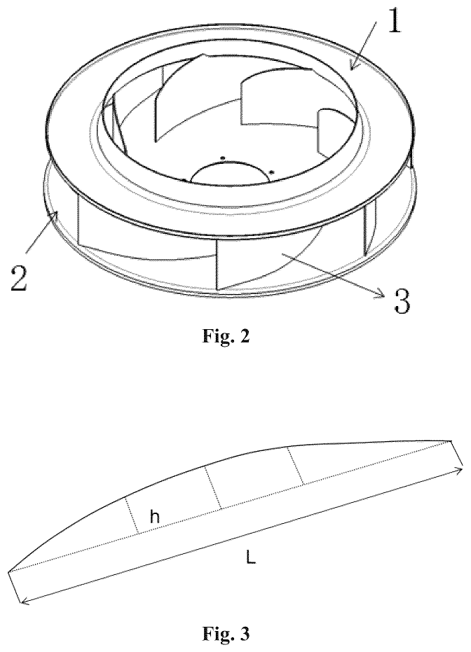

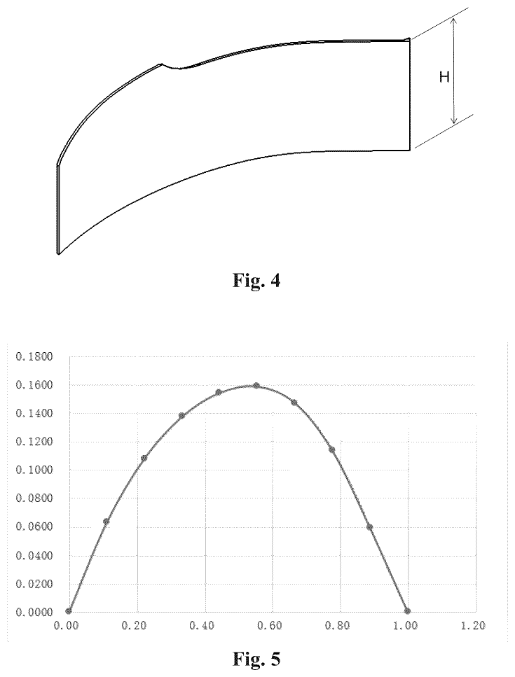

Referring to FIG. 1 to FIG. 5, FIG. 1 is a flowchart of a blade design method; FIG. 2 is a schematic diagram of a target impeller structure; FIG. 3 is a schematic diagram of an element of a blade; FIG. 4 is a schematic diagram of a target blade structure; and FIG. 5 is a schematic diagram of a fitting optimization curve.

The present disclosure provides a blade design method, which specifically comprises the following steps.

At S1, target design parameters comprising a diameter of an impeller and the number of blades are obtained.

At S2, a chord length L of the blade is determined according to the diameter D of the impeller.

According to the chord length L of the blade, a camber h of the blade corresponding to the chord length L of the blade is determined by means of a fitting optimization curve of the chord length and the camber.

A height H of the blade is determined according to the diameter D of the impeller and the number z of blades.

At S3, an element of the blade is obtained according to the camber h of the blade, and a height of a corresponding position of the element of the blade is stretched to the height H of the blade to obtain a target blade structure 3.

Herein, the diameter D of the impeller and the number z of blades are determined according to the working conditions and customer requirements. The diameter D of the impeller is usually determined in three aspects.

Firstly, the size of the impeller is limited by the installation size required by a customer, such as the size of an air conditioner, a purifier, a range hood, a vacuum cleaner and other terminal products.

Secondly, according to the working conditions, parameters such as air volume, pressure, power, and efficiency of the impeller are mainly included, for example, if the diameter D of the impeller is too small, the pressure and the flow rate cannot the designed target values, and can only be achieved by increasing the size; and if the diameter D of the impeller is too large, the working range of the impeller is too large, and the efficiency of the pressure and the flow rate is low, so that it is necessary to reduce the size or use other methods to improve the efficiency.

Thirdly, according to existing products, the sizes of the existing products can serve as a reference by considering market compatibility and well-performing manufacturers.

The final determined diameter of the impeller is obtained by combining the above factors. In the present disclosure, the diameter D of the impeller may be obtained directly by a designer, for example, obtained by inputting through an input device, or obtained from other devices through data transmission.

The number z of blades is usually determined in two aspects.

On the one hand, the number z of blades of a current centrifugal fan is substantially 4 to 9.

On the other hand, according to the working conditions, the parameters such as air volume, pressure, power, and efficiency are mainly included, and the optimal number z of blades is tested and determined by simulation means or tests.

In addition, the above fitting optimization curve may be a result obtained by a large number of simulation tests, firstly, the optimal solution for the element of the blade is obtained by simulation tests, and then the fitting optimization curve of the chord length and the camber is obtained by fitting according to the different positions of the obtained chord length of the element of the blade and the corresponding camber.

Due to the fact that the camber h of the blade in the blade design method provided by the present disclosure is obtained by the existing fitting optimization curve, and the fitting optimization curve may be a curve with high efficiency and small loss, so that the finally obtained target blade structure 3 also has the characteristics of high efficiency and small loss, and more importantly, in the design process, through the method of obtaining the target blade structure 3 by the existing fitting optimization curve, the target blade structure 3 corresponding to the current chord length L of the blade may be obtained by substituting the chord length L of the blade into the curve. Repeated checking and adjustment are not needed, and only the conditions of the fitting optimization curve need to be met, so that the design mode is simple and convenient, and batch and rapid design can be realized.

Optionally, the fitting optimization curve may also be a curve with other characteristics.

On the basis of the above embodiment, the step of determining the chord length L of the blade according to the diameter D of the impeller in S2 specifically comprises the following step.

At S21, the chord length L of the blade is determined according to a formula L=(0.4−0.6)D.

Where L is chord length of the blade and D is the diameter of the impeller.

The diameter D of the impeller determines the maximum and minimum sizes of the chord length L of the blade. If the chord length L of the blade is too large, there is a danger of exceeding the diameter D of the impeller and interference between the blades, and if the chord length L of the blade is too small, there is a problem of unreasonable impeller arrangement.

The above parameters may be obtained by performing simulation tests through fluid simulation software, and finally, it is determined that the chord length L of the blade obtained by the parameters is optimal. According to the formula of determining the chord length L of the blade obtained according to a large number of simulation tests, it can be ensured that the finally obtained target blade structure 3 has the optimal working condition parameters, thereby improving the working efficiency of the blade.

On the basis of the above embodiment, the step of determining, according to the chord length L of the blade, the camber h of the blade corresponding to the chord length L of the blade by means of the fitting optimization curve of the chord length and the camber in S2 specifically comprises the following step.

At S22, when the chord length L of the blade is equally divided into n parts, and a reference position x is selected from 0, 1/n to n/n in sequence through a formula:

$$y = 2.7 \; 97 {x}^{6} - 6.9 \; 249 {x}^{5} + 5.8 \; 101 {x}^{4} - 1.8 \; 368 {x}^{3} - 0.4 \; 797 {x}^{2} + 0.6 \; 343 x ;$$

$$h = Ly ;$$

A camber h of n+1 reference positions respectively corresponding to n+1 reference x is obtained.

Where y is a ratio of the camber of the reference position to the chord length L of the blade, x is a ratio of the chord length of the reference position to the chord length L of the blade, h is the camber of the reference position, and L is the chord length of the blade.

Through a large number of tests, a fitting optimization curve equation initially obtained according to the optimal element of the blade is as follows:

$$y = 2.7 \; 97 {x}^{6} - 6.9 \; 249 {x}^{5} + 5.8 \; 101 {x}^{4} - 1.8 \; 368 {x}^{3} - 0.4 \; 797 {x}^{2} + 0.6 \; 343 x + 7 E - 06$$

Since the curve needs to pass through a point (0, 0) to achieve the desired shape of the element of the blade, a constant 7E-06 in the above formula is omitted without affecting the shape of the curve, and the influence of the finally obtained fitting optimization curve equation relative to the chord length L of the blade is very small.

The fitting optimization curve has the characteristics of high efficiency and small loss, and is suitable for design of blades of different sizes, so that in the design process, the camber h of the blade may be obtained by the fitting optimization curve equation, repeated checking and adjustment are not needed, the design mode is simple and convenient, batch and rapid design can be realized, and the designed blade also has the characteristics of high efficiency and small loss.

On the basis of the above embodiment, n is greater than or equal to 4.

If n is less than 4, the number of segments equally divided by the chord length L of the blade is too small, and an interval between the reference positions is too large. Even after the camber of the reference position is obtained, the deviation from the fitting optimization curve is large, so that the element of the blade drawn may not have the characteristics of high efficiency and small loss, and the error is large.

In this embodiment, referring to FIG. 5, n is selected to be equal to 9, x is selected from 0, 1/9, 2/9 to 9/9 in sequence, the camber corresponding to the chord length may be obtained according to the chord length corresponding to the taken X, and the fitting optimization curve in the figure is finally fitted by the chord length and the camber.

On the basis of the above embodiment, the step of determining the height H of the blade according to the diameter D of the impeller and the number z of blades in S2 specifically comprises the following step.

At S23, the height of the blade is determined by the following formula, H=(0.5−2)D/z.

Where H is the height of the blade, D is the diameter of the impeller, and z is the number of blades.

The height H of the blade that is too high or too low cannot meet the installation size. After tests, the height H of the blade within the range obtained by the above formula has the optimal blade performance and can reduce the loss.

On the basis of any of the above solutions, after the step of obtaining the element of the blade according to the camber h of the blade, and stretching the height of the corresponding position of the element of the blade to the height H of the blade to obtain the target blade structure 3 in S3 comprises the following steps.

At S4, a wheel disc model 2 and a wheel cover model 1 are obtained.

At S5, a Boolean summation operation is performed on the target blade structure 3, the wheel disc model 2, and the wheel cover model 1 to determine a final target impeller structure.

Specifically, a part where the target blade structure 3, the wheel disc model 2, and the wheel cover model 1 intersect according to a preset position relationship is obtained by the Boolean summation operation, and the redundant parts are removed to finally obtain the target impeller structure.

Through the Boolean summation operation, the design mode is simpler and more convenient, and the efficiency of the finally obtained target impeller structure is increased, and the pressure becomes large.

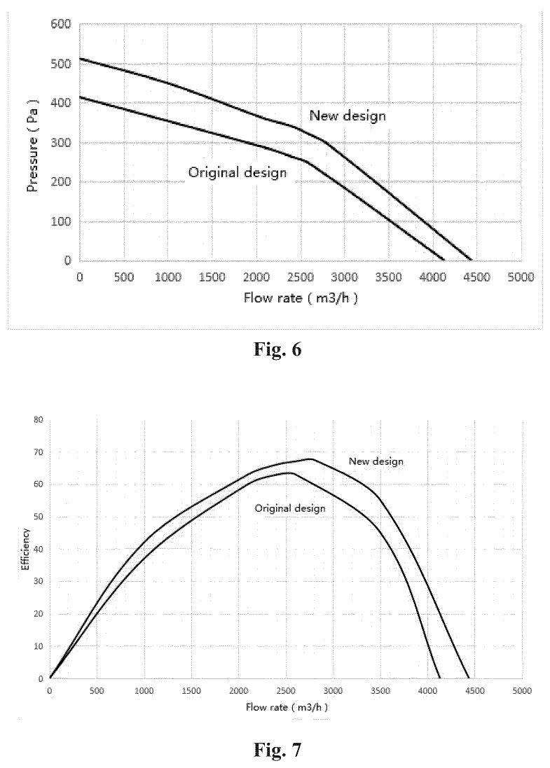

Referring to FIGS. 6 and 7, FIG. 6 is a relational graph between a flow rate and a pressure of a blade obtained by a method provided by the present disclosure when in use; and FIG. 7 is a relational graph between a flow rate and efficiency of a blade obtained by a method provided by the present disclosure when in use. The blade obtained by the design method provided by the present disclosure has the similar characteristics to the original curve when in use, for example, compared with a blade obtained by a common design method, the blade obtained in the present disclosure bears a larger pressure and a higher efficiency under the same flow rate condition.

In addition to the above blade design method, the present disclosure further provides a blade design system for implementing the above method. The blade design system mainly structurally comprises a data acquisition module, a design module, and a forming module.

The data acquisition module is configured to obtain target design parameters comprising a diameter D of an impeller and the number z of blades.

The design module is configured to determine a chord length L of the blade according to the diameter D of the impeller; determine, according to the chord length L of the blade, a camber h of the blade corresponding to the chord length L of the blade by means of a fitting optimization curve of the chord length and the camber; and determine a height H of the blade according to the diameter D of the impeller and the number z of blades.

The forming module is configured to obtain an element of the blade according to the camber h of the blade, and stretch a height of a corresponding position of the element of the blade to the height H of the blade to obtain a target blade structure 3.

The data acquisition module is connected to the design module, and the design module is connected to the forming module.

When in use, after obtaining the target design parameters, the data acquisition module transmits the parameters to the design module, the design module obtains the chord length L of the blade, the camber h of the blade, and the height H of the blade according to the parameters, the design module transmits the obtained data to the forming module, and the forming module stretches the target blade structure 3 according to the obtained data.

The design module comprises three sub-modules, namely a chord length design module, a camber design module, and a height design module.

The chord length design module is configured to determine the chord length L of the blade according to the diameter D of the impeller, specifically according to a formula L=(0.4−0.6)D.

Where L is chord length of the blade and D is the diameter of the impeller.

The camber design module is configured to determine, according to the chord length L of the blade, the camber h of the blade corresponding to the chord length L of the blade by means of the fitting optimization curve of the chord length and the camber, specifically when the chord length of the blade is equally divided into n parts, and a reference position x is selected from 0, 1/n to n/n in sequence through a formula:

$$y = 2.7 \; 97 {x}^{6} - 6.9 \; 249 {x}^{5} + 5.8 \; 101 {x}^{4} - 1.8 \; 368 {x}^{3} - 0.4 \; 797 {x}^{2} + 0.6 \; 343 x ;$$

$$h = Ly ;$$

obtain a camber h of n+1 reference positions x respectively corresponding to n+1 reference x.

Where y is a ratio of the camber of the reference position to the chord length of the blade, x is a ratio of the chord length of the reference position to the chord length of the blade, h is the camber of the reference position, and L is the chord length of the blade.

And n is greater than or equal to 4.

The height design module is configured to determine the height H of the blade according to the diameter D of the impeller and the number z of blades, specifically according to the following formula:

$$H = ( 0.5 - 2 ) D / z$$

Where H is the height of the blade, D is the diameter of the impeller, and z is the number of blades.

The data acquisition module, the forming module, and the above three sub-modules are the provided with an input unit and an output unit, the input unit of the data acquisition module is connected to an input device while the output unit thereof is connected to the input unit of the chord length design module, the output unit of the chord length design module is connected to the input unit of the camber design module, the output unit of the camber design module is connected to the input unit of the height design module, and the output unit of the height design module is connected to the input unit of the forming module.

On the basis of the above embodiment, the blade design system further comprises a model acquisition module and an operation module. The model acquisition module is configured to obtain a wheel disc model 2 and a wheel cover model 1. The operation module is configured to perform a Boolean summation operation on the target blade structure 3, the wheel disc model 2, and the wheel cover model 1 to determine the final target impeller structure. The operation module is connected to the model acquisition module and the forming module.

After the forming module obtains the target blade structure 3, the target blade structure 3 is transmitted to the operation module, the model acquisition module transmits the obtained wheel disc model 2 and the wheel cover model 1 to the operation module, and the operation module performs the Boolean summation operation on the target blade structure 3, the wheel disc model 2, and the wheel cover model 1 to finally obtain the target impeller structure.

The blade design system is configured to perform the blade design method, and functions of parts thereof may be specifically referred to the steps of the above method, and this embodiment is briefly described, and those skilled in the art may obtain various functional operations of the system with reference to the above method.

In addition to the blade design method and the blade design system, the present disclosure further provides a blade, which is obtained according to the blade design method in the above embodiment, and an efficient equal-thickness impeller, comprising a blade obtained according to the blade design method in the above embodiment. The structure of other parts of the blade and the efficient equal-thickness impeller is referred to the related art, which will not be elaborated herein.

The various embodiments in the present specification are described in a progressive manner, and each embodiment focuses on differences from other embodiments, and the same similar parts between the various embodiments may be referred to each other.

The blade design method, the blade design system, the blade, and the efficient equal-thickness impeller provided by the present disclosure are described in detail above. The principles and implementations of the present disclosure are described herein using specific examples, the foregoing description of the embodiments are only used to help the understanding of the method and core concept of the present disclosure. It is to be noted that the number of variations and modifications may be made by those of ordinary skill in the art without departing from the conception of the present disclosure, and all fall within the scope of protection of the present disclosure.

1. A blade design method, comprising:
obtaining target design parameters comprising a diameter of an impeller and the number of blades;
determining a chord length of the blade according to the diameter of the impeller;
according to the chord length of the blade, determining a camber of the blade corresponding to the chord length of the blade by means of a fitting optimization curve of the chord length and the camber;
determining a height of the blade according to the diameter of the impeller and the number of blades; and
obtaining an element of the blade according to the camber of the blade, and stretching a height of a corresponding position of the element of the blade to the height of the blade to obtain a target blade structure;
wherein said according to the chord length of the blade, determining the camber of the blade corresponding to the chord length of the blade by means of a fitting optimization curve of the chord length and the camber comprises:
when the chord length of the blade is equally divided into n parts, and a reference position x is selected from 0, 1/n to n/n in sequence through a formula:
$$v = 2.7 \; 97 {x}^{6} - 6.9 \; 249 {x}^{5} + 5.8 \; 101 {x}^{4} - 1.8 \; 368 {x}^{3} - 0.4 \; 797 {x}^{2} + 0.6 \; 343 x ;$$
$$h = Ly ; .$$
obtaining a camber h of n+1 reference positions x respectively corresponding to n+1 reference positions x;
where y is a ratio of the camber of the reference position to the chord length of the blade, x is a ratio of the chord length of the reference position to the chord length of the blade, h is the camber of the reference position, and L is the chord length of the blade.

2. The blade design method as claimed in claim 1, wherein said determining the chord length of the blade according to the diameter of the impeller comprises:
determining the chord length of the blade according to a formula L=(0.4−0.6)D;
where L is the chord length of the blade and D is the diameter of the impeller.

3. (canceled)

4. The blade design method as claimed in claim 1, wherein n is greater than or equal to 4.

5. The blade design method as claimed in claim 1, wherein said determining a height of the blade according to the diameter of the impeller and the number of blades comprises: determining the height of the blade through the following formula:
$$H = ( 0.5 - 2 ) D / z ;$$
where H is the height of the blade, D is the diameter of the impeller, and z is the number of blades.

6. The blade design method as claimed claim 1, wherein after the element of the blade is obtained according to the camber of the blade, and the height of the corresponding position of the element of the blade is stretched to the height of the blade to obtain the target blade structure, the method further comprises:
obtaining a wheel disc model and a wheel cover model; and
performing a Boolean summation operation on the target blade structure, the wheel disc model, and the wheel cover model to determine a final target impeller structure.

7. A blade design system, comprising:
a data acquisition module, configured to obtain target design parameters comprising a diameter of an impeller and the number of blades;
a design module, configured to determine a chord length of the blade according to the diameter of the impeller; determine, according to the chord length of the blade, a camber of the blade corresponding to the chord length of the blade by means of a fitting optimization curve of the chord length and the camber; and determine a height of the blade according to the diameter of the impeller and the number of blades; and
a forming module, configured to obtain an element of the blade according to the camber of the blade, and stretch a height of a corresponding position of the element of the blade to the height of the blade to obtain a target blade structure;
wherein the data acquisition module is connected to the design module, and the design module is connected to the forming module.

8. The blade design system as claimed in claim 7, further comprising:
a model acquisition module, configured to obtain a wheel disc model and a wheel cover model; and
an operation module, configured to perform a Boolean summation operation on the target blade structure, the wheel disc model, and the wheel cover model to determine the final target impeller structure, wherein the operation module is connected to the model acquisition module and the forming module.

9. A blade, wherein the blade is obtained by the blade design method as claimed in claim 1.

10. An efficient equal-thickness impeller, comprising the blade as claimed in claim 9.
